(19) United States
(12) Patent Application Publication
(10) Pub. No.: US 2015/0000974 A1
(43) Pub. Date: Jan. 1, 2015

(54) ROUTING STRUCTURE OF WIRE HARNESS AND METHOD FOR FORMING SAID ROUTING STRUCTURE

(71) Applicants: Kouki Shiga, Yokkaichi (JP); Minoru Okuyama, Yokkaichi (JP)

(72) Inventors: Kouki Shiga, Yokkaichi (JP); Minoru Okuyama, Yokkaichi (JP)

(73) Assignee: SUMITOMO WIRING SYSTEMS, LTD., Yokkaichi, Mie (JP)

(21) Appl. No.: 14/377,787

(22) PCT Filed: Jul. 4, 2012
(86) PCT No.: PCT/JP2012/067058

§ 371 Date: Aug. 8, 2014

(30) Foreign Application Priority Data
Feb. 23, 2012 (JP) 2012-038025

(51) Int. Cl. B60R 16/02; H01B 13/012

(52) U.S. Cl. CPC B60R 16/0222; H01B 13/01263
USPC 174/72 A; 29/825

(57) ABSTRACT

A routing structure of a wire harness is continuously routed by being bent upward from two ends of an under-floor routed area under a floor of an automobile body, and being drawn out, at least on the rear side, to above the floor through a through-hole formed in a floor panel of the automobile body, wherein the wire harness is inserted into a continuous metal pipe, the metal pipe is bent upward at a location where the metal pipe is inserted into the through-hole of the floor panel, the metal pipe into which the wire harness is inserted is routed through the through-hole, a grommet is externally fitted on and fixed to a region of the metal pipe that is inserted into the through-hole, and a seal lip provided on the grommet is pressed against the lower surface of the floor panel from the underfloor side to block water.

### TECHNICAL FIELD

The present invention relates to a routing structure of a wire harness and a method for forming the routing structure, and in particular to a routing structure of a wire harness including high-voltage electric power lines that is routed under the floor of an electric automobile or hybrid automobile.

### BACKGROUND ART

Conventionally, in hybrid automobiles and electric automobiles, a wire harness that is routed between, for example, a battery and an inverter, or the inverter and a motor is often routed in an under-floor area below a floor panel because the wire harness includes high-voltage electric power lines serving as noise generation sources, in which the wire harness is inserted into a metal shield pipe in the above-described under-floor routing area and two end sections of the wire harness are bent upward and routed to above the floor.

For example, in JP 2004-224156A (Patent Document 1), as shown in

FIGS. 9A, 9B and 9C, a wire harness 100 that is constituted by three-phase high-pressure cables and connects an inverter 101 installed on the rear side of an automobile to a motor 102 arranged in an engine room is laid under the floor and, in this under-floor routing area, the high-pressure cables are respectively inserted into metal protection pipes 110. As shown in FIG. 9C, the protection pipes 110 terminate on the underfloor side, and a bracket 115 is fixed to the termination section.

Electric wires 100W of the wire harness 100 that are drawn out from the protection pipes 110 are respectively inserted into through-holes 122 formed in a floor panel 120, and the bracket 115 is bolted to the lower surface of the floor panel 120.

Note that there may be often a case where the protection pipes 110 terminate in the horizontal direction in which the routing in the underfloor area is performed, and only the electric wires of the wire harness that are drawn out from the protection pipes are bent upward and inserted into the through-holes formed in the floor panel.

### CITATION LIST

### Patent Documents

Patent Document 1: JP 2004-224156A

### SUMMARY OF INVENTION

### Technical Problem

As described above, when the metal protection pipes 110 are arranged only under the floor, and the electric wires 100W of the wire harness 100 that are drawn out from the protection pipes 110 are respectively inserted upward into the through-holes 122 of the floor panel 120 from the lower side, there is the problem that the electric wires 100W hang downward, deteriorating workability of insertion into the through-holes 122. Also, when the wire harness is drawn out from the protection pipes at an underfloor position, the wire harness may be damaged by being hit by a flying stone from the ground or interfering with the road surface. Furthermore, when the floor panel is shifted due to a vehicular crash or the like, the wire harness that is inserted into the through-holes 122 of the floor panel may be damaged or cut by coming into contact with the inner peripheral edges of the moving through-holes.

Furthermore, as shown in FIG. 9C, it is not easy to provide bent sections 115a that can be latched in the sealed state on the bracket 115 at the terminals of the metal protection pipes 110 by metal bending processing, thus causing the problem of the low reliability in waterproof property. Accordingly, there is the problem that water is likely to invade the group of electric wires of the wire harness 100 that are drawn out from the protection pipes 110.

The present invention was made in view of the above-described problems, and it is an object of the present invention to make it easy for a wire harness that is routed under the floor to be inserted into a through-hole of the floor panel from the lower side, to improve the protection function of the wire harness, and to prevent water from invading the group of electric wires of the wire harness.

### Solution to Problem

In order to solve the above-described problems, the present invention is directed to a routing structure of a wire harness that is routed continuously by being bent upward at both ends of an under-floor routed area under a floor of an automobile body, and being drawn out, at least on the rear side, to above the floor through a through-hole formed in a floor panel of the automobile body, wherein the wire harness is inserted into a continuous metal pipe, a partition wall being provided in the metal pipe, the electric wires of the wire harness being respectively inserted into hollow parts separated by the partition wall, and the partition wall having a shape having a bending point that serves as a starting point in bending processing of the metal pipe, the metal pipe is bent upward at a location where the metal pipe is inserted into the through-hole of the floor panel, the metal pipe into which the wire harness is inserted is routed to above the floor through the through-hole, a grommet is externally fitted on and fixed to a region of the metal pipe that is inserted into the through-hole, and a seal lip provided on the grommet is pressed against a lower surface of the floor panel from the underfloor side to block water.

The metal pipe is formed by extrusion molding of metal. The metal is preferably aluminum-based metal due to its light weight and excellence in corrosion resistance and workability, but it is also possible that the metal pipe is made of stainless-based or iron-based metal, and the outer circumferential surface of the metal pipe is coated with a resin or a paint.

Although a plurality of electric wires constituting the wire harness are preferably inserted into a single metal pipe, a configuration is also possible in which, as with in Patent Document 1, the electric wires are respectively inserted into a plurality of metal pipes, and the metal pipes are bound together. Furthermore, the metal pipe may be circular, or may be elliptical or oval.

In the present invention, the wire harness in which an above-floor routed area and an under-floor routed area are continuous with each other is inserted into the metal pipe, and the metal pipe is bent upward from two ends of a horizontally routed section, which serves as the under-floor routed area, so as to provide upward bent sections. When, on the rear side, the metal pipe into which the wire harness is inserted is inserted upward into a through-hole formed in the floor panel from the lower side, the electric wires of the wire harness are inserted not alone but with the metal pipe and thereby rigidity is improved, making it possible to prevent the electric wires from hanging and to improve workability of insertion into the through-hole.

Also, since the grommet is mounted on a region of the metal pipe that passes through the through-hole, it is possible to prevent water from invading from the through-hole, and since the wire harness is inserted into the metal pipe, it is possible to prevent water from invading the group of electric wires of the wire harness.

It is preferable that the wire harness constituted by a group of multiple electric wires be inserted into a single metal pipe, and the metal pipe be made of aluminum-based metal.

It is preferable that the outer surface of the grommet be covered with an aluminum-based metal bracket, and the metal bracket be bolted to the floor panel.

The partition wall is provided in the metal pipe, and the electric wires of the wire harness are respectively inserted into hollow parts separated by the partition wall, and the partition wall has the shape having a bending point that serves as a starting point in bending processing of the metal pipe.

As described above, by providing the partition wall in the metal pipe, it is possible to improve shielding property. Furthermore, when performing bending processing on the metal pipe, the bending point of the partition wall serves as a bending starting point, making it possible to smoothly bend the metal pipe and to form the through-hole insertion section that is bent from the horizontally routed section.

The wire harness is routed, on the rear side of an electric automobile or hybrid automobile, from a position above the floor to the under-floor routed area outside of the automobile through the through-hole of the floor panel, and is routed, on the front side, into an engine room.

The wire harness is connected to a battery above the floor on the rear side and to an inverter in the engine room, or the wire harness is connected to the inverter above the floor on the rear side and to a motor in the engine room. Note that the present invention is applicable to the case where the wire harness is routed from above the floor on the rear side to under the floor, and is routed to above the floor at an intermediate position of the automobile in the length direction.

Furthermore, the present invention provides a method for forming the routing structure of a wire harness. That is, the method includes: inserting the wire harness into the metal pipe that is a straight pipe; bending the metal pipe upward together with the wire harness provided within the metal pipe; externally fitting and fixing a grommet at a required position of the upward bent section of the metal pipe; routing the central section under the floor of the automobile body, then inserting the upward bent section into the through-hole of the floor panel, and bringing the seal lip of the grommet into close contact with a peripheral edge of the through-hole.

### Advantageous effects of Invention

As described above, according to the present invention, a wire harness in which an above-floor routed area and an under-floor routed area are continuous with each other is inserted into a continuous metal pipe, the metal pipe is bent, and the metal pipe into which the wire harness is inserted is inserted into a through-hole of a floor panel. Therefore, it is possible to hold the wire harness in the state in which it is directed upward during insertion of the wire harness into the through-hole, and thus insertion workability can be improved. Furthermore, even in case where the floor panel is shifted due to a crash or the like, the peripheral edge of the through-hole only collides with the metal pipe without getting into direct contact with a group of electric wires of the wire harness, thus making it possible to prevent the electric wires from being damaged.

### BRIEF DESCRIPTION OF DRAWINGS

FIG. 1 is a schematic side view illustrating a first embodiment of the present invention.

FIGS. 2A and 2B illustrate a metal pipe into which electric wires of a wire harness are inserted, namely, FIG. 2A is a side view and FIG. 2B is a cross-sectional view taken along the line I-I of FIG. 2A.

FIG. 3 is a cross-sectional view of an end of the metal pipe.

FIG. 4 is a cross-sectional view illustrating a grommet that is to be fixed to the metal pipe.

FIG. 5 is a cross-sectional view illustrating the state in which the metal pipe is inserted into a through-hole of a floor panel and a grommet is fixed to the floor panel.

FIG. 6 is a schematic side view illustrating a metal pipe according to a second embodiment.

FIG. 7A is a perspective view illustrating the metal pipe, and FIG. 7B is a front view illustrating the state in which the electric wires are inserted into the metal pipe.

FIG. 8 is a cross-sectional view illustrating the state in which a grommet fixed to the metal pipe is fitted into the through-hole of the floor panel.

FIGS. 9A, 9B and 9C are diagrams illustrating a conventional example.

### DESCRIPTION OF EMBODIMENTS

Hereinafter, embodiments of the present invention will be described with reference to the accompanying drawings.

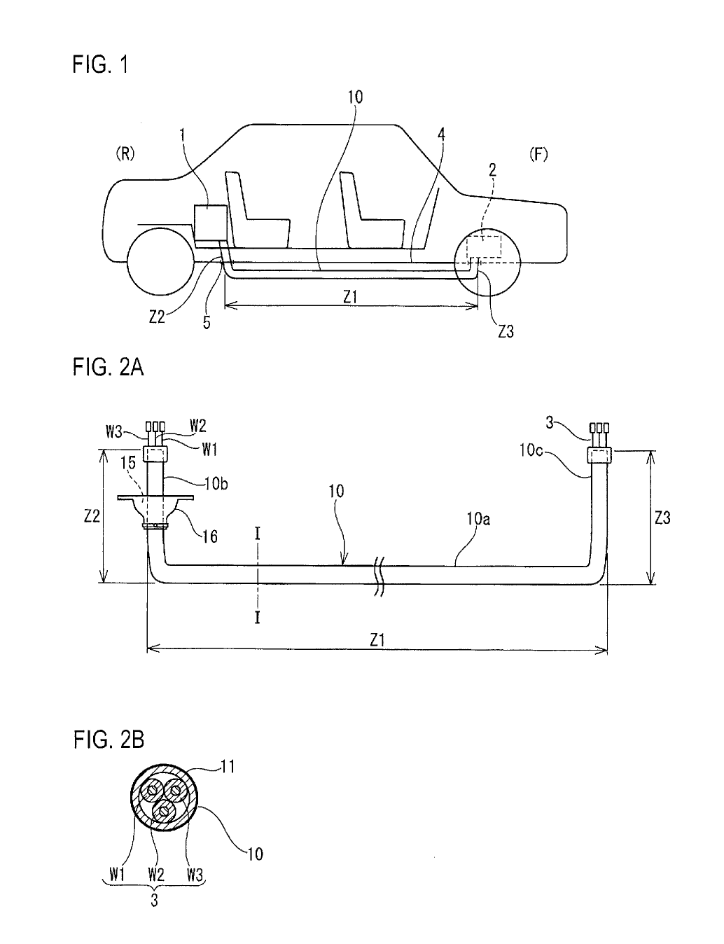

FIGS. 1 to 5 show a first embodiment. In the present embodiment, as shown in FIG. 1, a wire harness 3 constituted by three-phase high-voltage electric power lines W1, W2, and W3 is routed between a battery 1 installed on the floor of a hybrid automobile on the rear side and an inverter 2 installed in an engine room on the floor on the front side, and an intermediate area of the wire harness 3 between the area above the floor on the rear side and the area above the floor on the front side is laid under a floor panel 4. An under-floor routed area Z1 is bent upward at its two ends in the length direction, and an upward routed area Z2 on the rear side is inserted into a through-hole 5 formed in the floor panel 4 on the rear side and laid above the floor panel on the rear side, while an upward routed area Z3 on the front side is laid into the engine room.

The wire harness 3 in which the under-floor routed area Z1 and the upward routed areas Z2 and Z3 on both sides of the under-floor routed area Z1 are continuously routed is inserted into a single continuous metal pipe 10. The metal pipe 10 functions as a shield pipe for preventing noise generated by the high-voltage electric power lines W1 to W3 from diffusing to the outside and as a protection pipe for protecting the wire harness that is routed under the floor against flying stones or protecting that wire harness from coming into contact with the road surface.

As shown in FIG. 2, the under-floor routed area Z1 of the metal pipe 10 serves as a horizontally routed section 10a that extends from the rear side to the front side and is substantially horizontally routed, and one end of the horizontally routed section 10a is bent upward at a position substantially beneath the through-hole 5 so as to provide an upward bent section 10b that passes through the through-hole 5 and the other end of the horizontally routed section 10a is also bent upward so as to provide an upward bent section 10c.

The upward bent section 10b of the metal pipe 10 is a section that passes through the through-hole 5 of the floor panel from the underfloor side and projects to above the floor. It is preferable that, above the floor, the metal pipe 10 is elongated to the position at which the electric wires of the wire harness 3 are connected to the battery 1 and the inverter 2 so as to be the single continuous metal pipe 10 serving as an armoring material of the wire harness 3. However, if the top end of the upward bent section 10b is further bent, it will be difficult for the upward bent section 10b to be inserted into the through-hole 5 from the lower side. Therefore, it is preferable that connectors be connected to terminals of the electric wires of the wire harness 3 that are drawn out from the top ends of the metal pipe 10, instead of performing bending processing, and the through-holes 5 be formed at positions at which the connectors can be fitted to connector fitting sections provided on the battery 1 and the inverter 2. Note that, when the connectors of the wire harness terminals that are drawn out from the top ends of the metal pipe 10 cannot be fitted to the connector fitting sections of the battery 1 and the inverter 2, it is preferable that the group of electric wires of the wire harness 3 be covered with a metal braided tube or metal braided sheet for shielding, a corrugated tube be externally fitted on the covered group of electric wires, and the wire harness 3 be routed to the positions at which the battery 1 and the inverter 2 are provided.

According to the present embodiment, the metal pipe 10 is formed by extrusion molding of aluminum-based metal due to its light weight, ease of processing, excellent corrosion resistance, and the like. The metal pipe 10 is molded in the shape of a straight tube, and is cut in a required length and used. The wire harness 3 constituted by the three high-voltage electric power lines is inserted into this metal pipe 10, and is drawn out from two ends of the metal pipe 10 in the length direction such that required lengths of the wire harness 3 protrude from the respective ends of the metal pipe 10.

After the wire harness 3 is inserted into the metal pipe 10, the metal pipe 10 is bent at its two ends so that the upward bent sections 10b and 10c are provided at respective ends of the horizontally routed section 10a.

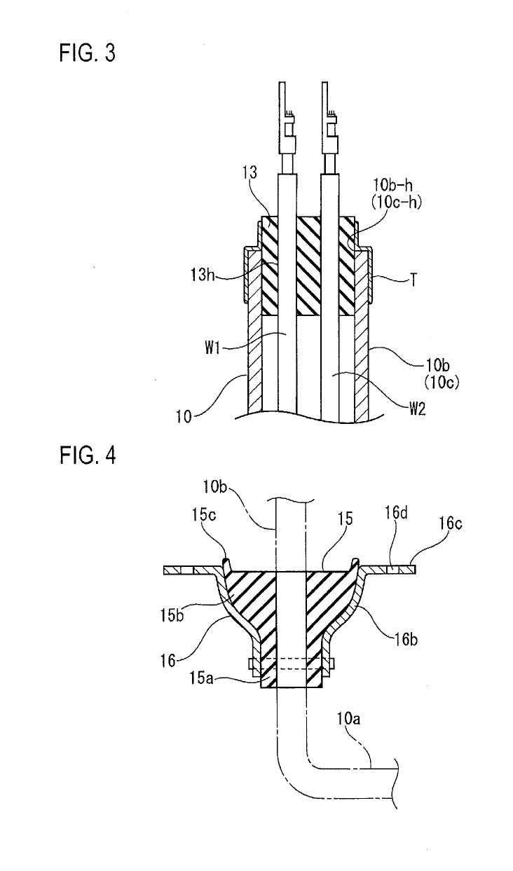

Also, as shown in FIG. 3, rubber stoppers 13 are mounted that are fitted into top openings 10b-h and 10c-h of the upward bent sections 10b and 10c that pass through the through-holes 5. The electric wires W1 to W3 are respectively inserted into three through-holes 13h formed in the rubber stoppers 13, and the rubber stoppers 13 are fixed to the outer circumferential surface of the metal pipe 10 with adhesive tapes T. With this, the group of electric wires of the wire harness 3 that are drawn out from the upward bent sections 10b and 10c of the metal pipe 10 is positioned and held at the top ends of the metal pipe 10.

Furthermore, as shown in FIG. 2B, a coating material 11 is applied to the outer circumferential surface of the metal pipe 10 so as to reliably prevent corrosion due to rain water and the like from occurring particularly in the under-floor routed area Z1. Since the wire harness 3 inserted into the metal pipe is constituted by the high-voltage electric power lines W1 to W3, the coating material 11 has a color for indicating that high-voltage electric power lines are included.

As shown in FIG. 4, a grommet 15 is externally fitted on the upward bent section 10b that passes through the through-hole 5. The grommet 15 is a cylinder made of elastomer, and the metal pipe 10 passes through the hollow part of the grommet 15 in a close contact state. The grommet 15 has a small-diameter cylindrical section 15a, and a large-diameter cylindrical section 15b that is continuous with the small-diameter cylindrical section 15a. The large-diameter cylindrical section 15b is provided, on its top surface, with a circular seal lip 15c that is configured to be pressed against a position on the outer periphery of the through-hole 5 of the floor panel 4 from the outside of the automobile.

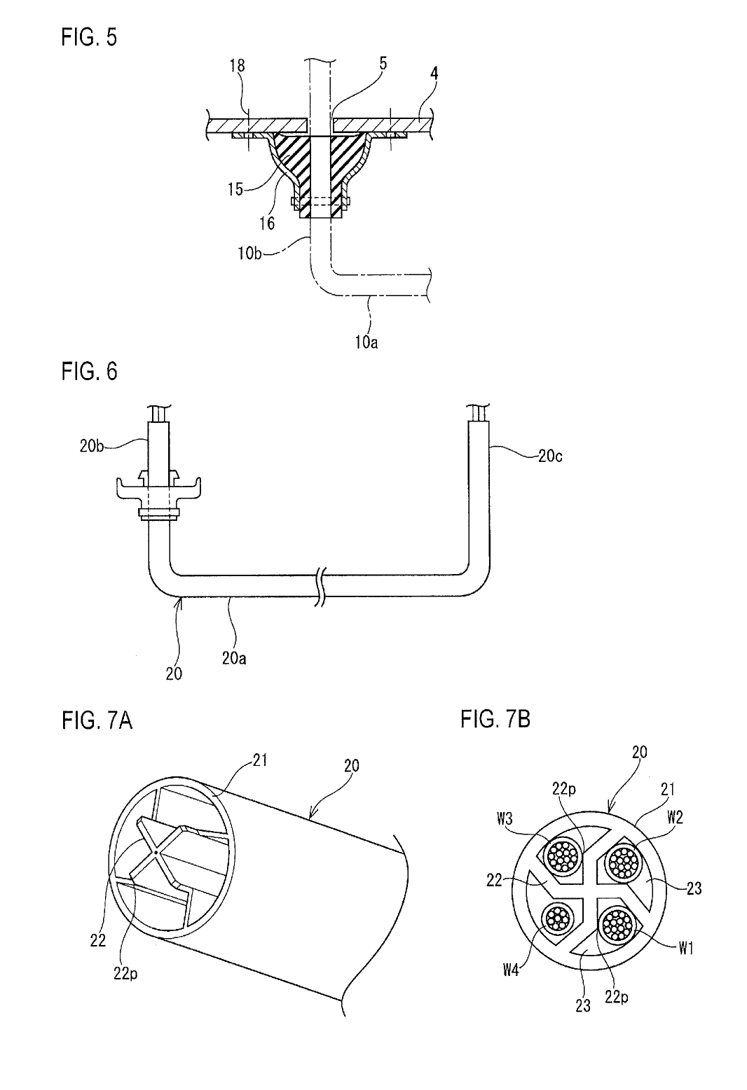

Furthermore, a metal bracket 16 made of aluminum-based metal is provided that covers the outer surfaces of the small-diameter cylindrical section 15a and the large-diameter cylindrical section 15b of the grommet 15. Furthermore, a flange section 16c is provided projecting from the top end of a large-diameter cylindrical section 16b that is externally fitted on the large-diameter cylindrical section 15b, and bolt holes 16d are formed in the flange section 16c. As shown in FIG. 5, the flange section 16c is pressed against the automobile exterior surface of the floor panel 4, and the grommet 15 is fixed to the floor panel 4 by fastening bolts 18.

In the process in which the wire harness 3 that is covered over its substantially entire length with the metal pipe 10 is mounted in an automobile, the horizontally routed section 10a of the metal pipe 10 is arranged on the bottom surface side of the floor panel 4 of the automobile, and the upward bent sections 10b and 10c on both sides thereof are held upward.

The upward bent section 10b on one side is inserted upward into the rear side through-hole 5 from the lower side, the flange section 16c of the metal bracket 16 is pressed against the lower surface of the floor panel 4, and the bolts 18 are fastened.

Then, the upward bent section 10c on the other side is laid into the engine room on the front side.

At the time of operation for inserting the upward bent section 10b of the metal pipe 10 upward into the through-hole 5 from the lower side, the wire harness 3 can be held upward without hanging, since the wire harness 3 is inserted into the metal pipe 10. Accordingly, it is possible to insert the wire harness 3 into the through-hole 5 in the state in which it is directed straight upward, resulting in an improvement in workability.

Furthermore, since the seal lip 15c of the grommet 15 is pressed against the outer peripheral edge of the through-hole 5, it is possible to prevent water from coming in through a space between the metal pipe 10 and the through-hole 5. In particular, since the wire harness 3 is inserted into the metal pipe 10 in a region passing through the through-hole 5, it is possible to reliably prevent the group of electric wires of the wire harness from being exposed to water.

Furthermore, in case where the floor panel 4 is shifted due to an automobile crash, the peripheral edge of the through-hole 5 only collides with the metal pipe 10 without getting into direct contact with the electric wires of the wire harness 3, thus making it possible to prevent the wire harness from being damaged.

FIGS. 6 to 8 show a second embodiment.

The second embodiment differs from the first embodiment in that a metal pipe 20 having a partition is used as the metal pipe. A description of the same configuration as that of the first embodiment, such as a configuration in which the metal pipe is bent at two ends of a horizontally routed section 20a so as to provide upward bent sections 20b and 20c, is omitted.

As with in the first embodiment, the metal pipe 20 is provided by extrusion molding of aluminum-based metal. The metal pipe 20 is constituted by a cylindrical peripheral wall 21 serving as a pipe main body, and four partition walls 22 that extend continuously in the axial direction of the peripheral wall 21 and project from the inner surface of the peripheral wall. The four partition walls 22 are formed so as to extend radially in cross-section from the center of the pipe, and provide divided four accommodation chambers 23. The high-voltage electric power lines W1, W2, and W3 are respectively inserted into three of the accommodation chambers 23, and a low-voltage electric wire W4 for a low-voltage battery is inserted into the remaining accommodation chamber 23.

By inserting, in this way, the high-voltage electric power lines W1 to W3 respectively into the accommodation chambers 23 while separating those electric power lines from one another, noise is prevented from diffusing to the outside, and by inserting the low-voltage electric wire W4 into the accommodation chamber 23, the noise from the high-voltage electric power lines W1 to W3 can be blocked.

Each partition wall 22 has, at its intermediate position in a radial direction, a single bent section 22p that extends continuously in the axis direction of the pipe. The provision of the bent section 22p at the intermediate position of the partition wall 22 in the radial direction makes it easy for the partition wall 22 to deflect in the radial direction. Therefore, when bending the metal pipe 20 to provide the upward bent sections 20b and 20c at two ends of the horizontally routed section 20a, the bent section 22p serves as a bending starting point, enabling the circular peripheral wall 21 to be smoothly bent. Also, even when the horizontally routed section 20a needs to be bent in the horizontal direction depending on the shape or the like of a routing region, it is possible to bend the metal pipe 20 relatively easily.

Also, as shown in FIG. 7A, in the openings at both ends of the metal pipe 20, the partition walls 22 project beyond the peripheral wall 21, the inserted electric wires W1 to W4 are fastened to the partition walls 22 with a fastening band, and the wire harness 3 is positioned and fixed to the metal pipe 10.

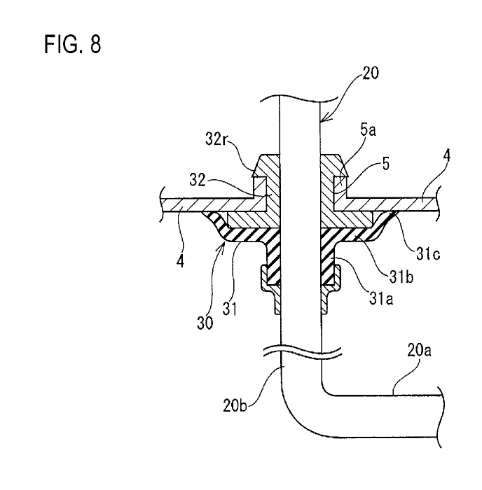

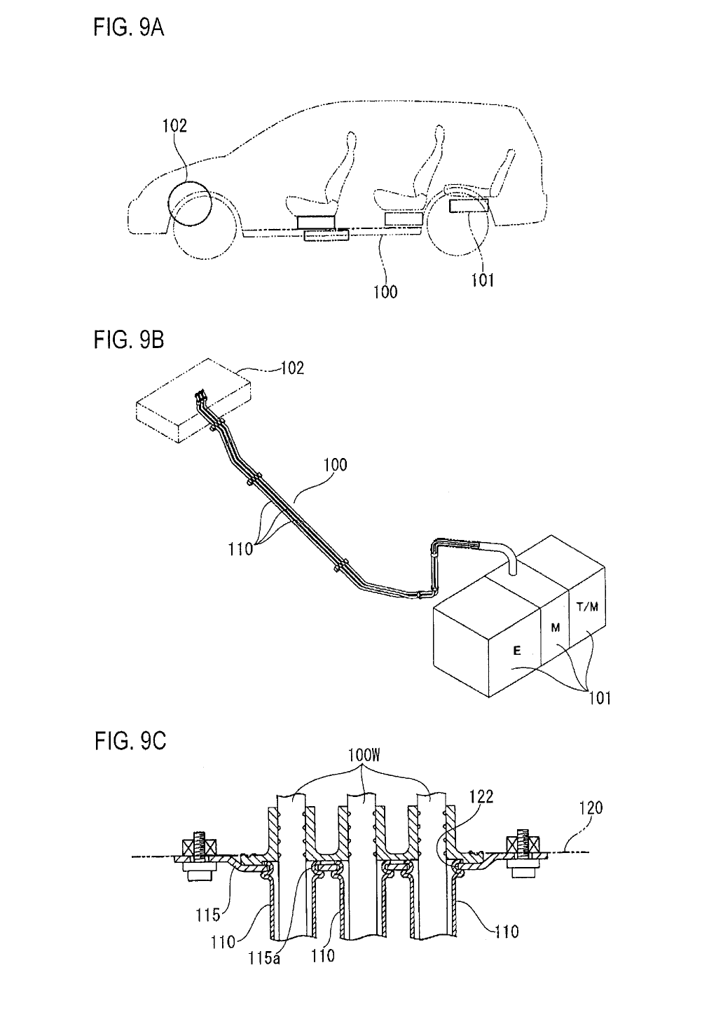

As shown in FIG. 8, the grommet 30 that is externally fitted on and fixed to the upward bent section 20b of the metal pipe 20 that passes through the through-hole of the floor panel is a two-component grommet that is constituted by a grommet main body 31 made of elastomer and a resin inner 32 made of a molded resin article. The grommet main body 31 has a small-diameter cylindrical section 31a through which the metal pipe 20 passes in a close contact state, and a large-diameter cylindrical section 31b that is continuous with the small-diameter cylindrical section 31a, and a seal lip 31c that is pressed against the automobile exterior surface of the floor panel 4 is provided on the top outer periphery of the large-diameter cylindrical section 31b. The cylindrical resin inner 32 is fitted into the large-diameter cylindrical section 31b of the grommet main body 31, the metal pipe 20 is inserted into the hollow part of the resin inner 32, and a latching claw 32r that is provided on the top outer periphery of the resin inner 32 is latched on the top end of a burring 5a projecting from the through-hole 5.

Since the grommet 30 is externally fitted on and fixed to the metal pipe 20, the metal pipe 20 can be inserted upward into and fixed to the through-holes 5 of the floor panel 4 from the lower side with substantially one step.

Furthermore, since the partition walls 22 are provided in the metal pipe 20 and the electric wires are separated from one another by the partition walls 22, it is possible to enhance the shielding property. Also, the electric wires within the pipe are prevented from moving or inclining in the radial direction of the pipe while interfering with each other, and thus it is possible to prevent the electric wires from being damaged.

The present invention is not limited to the first and second embodiments, and the metal pipe may have the shape of an ellipse or oval whose long axis is set in the horizontal direction and whose short axis is set in the vertical direction.

Furthermore, when partition walls are provided in an ellipsoidal or oval metal pipe, the partition walls may be provided in the shape of a comb, instead of radially.

Moreover, the metal pipe may be provided with upward inclined sections on both sides of the horizontally routed section, and the upward inclined sections be each provided with an upward vertical section.

### LIST OF REFERENCE NUMERALS

1 Battery

2 Inverter

4 Floor panel

5 Through-hole

10 Metal pipe

10a Horizontally routed section

10b, 10c Upward bent section

15 Grommet

16 Metal bracket

1-6. (canceled)

7. A routing structure of a wire harness that is routed continuously by being bent upward from two ends of an under-floor routed area under a floor of an automobile body, and being drawn out, at least on the rear side, to above the floor through a through-hole formed in a floor panel of the automobile body, the routing structure comprising:
a continuous metal pipe into which the wire harness is inserted, the metal pipe being bent upward at a location where the metal pipe is inserted into the through-hole of the floor panel;
a partition wall that is provided in the metal pipe, the partition wall having a shape with a bending point that serves as a starting point in bending processing of the metal pipe;
a grommet that is externally fitted on and fixed to a region of the metal pipe that is inserted into the through-hole; and
a seal lip provided on the grommet that is pressed against a lower surface of the floor panel from an under-floor side to block water, wherein
the electric wires of the wire harness are inserted into hollow parts separated by the partition wall, respectively, and
the metal pipe into which the wire harness is inserted is routed to an area above the floor through the through-hole.

8. The routing structure of a wire harness according to claim 7, wherein the wire harness that is constituted by a group of multiple electric wires is inserted into a single metal pipe, and the metal pipe is made of aluminum-based metal.

9. The routing structure of a wire harness according to claim 7, wherein the outer surface of the grommet is covered with an aluminum-based metal bracket, and the metal bracket is bolted to the floor panel.

10. The routing structure of a wire harness according to claim 7, wherein
the wire harness is routed on the rear side of an electric automobile or hybrid automobile from a position above the floor to the under-floor routed area outside of the automobile through the through-hole, and is routed on the front side into an engine room, and
the wire harness is connected to a battery above the floor on the rear side and to an inverter in the engine room, or the wire harness is connected to the inverter above the floor on the rear side and to a motor in the engine room.

11. A method for forming the routing structure of a wire harness according to claim 7, comprising the steps of:
inserting the wire harness into the metal pipe that is a straight pipe;
bending the metal pipe upward together with the wire harness provided within the metal pipe;
externally fitting and fixing a waterproof grommet at a required position of the upward bent section of the metal pipe that is inserted into the through-hole of the automobile body; and
routing a central section under the floor of the automobile body, then inserting the upward bent section to which the grommet is fixed into the through-hole of the floor panel, thereby bringing the seal lip of the grommet into close contact with a peripheral edge of the through-hole.
